(19) United States
(12) Patent Application Publication
(10) Pub. No.: US 2016/0258849 A1
(43) Pub. Date: Sep. 8, 2016

(54) CONTAINER, BIOLOGICALLY RELEVANT MATERIAL PURIFICATION CARTRIDGE, AND BIOLOGICALLY RELEVANT MATERIAL PURIFICATION CARTRIDGE ASSEMBLY KIT

(71) Applicant: Seiko Epson Corporation, Tokyo (JP)

(72) Inventors: Toshiro MURAYAMA, Fujimi (JP); Yuji SAITO, Shiojiri (JP); Fumio TAKAGI, Chino (JP); Kazuhisa MIYASAKA, Suwa (JP)

(21) Appl. No.: 15/057,485

(22) Filed: Mar. 1, 2016

(30) Foreign Application Priority Data
Mar. 2, 2015 (JP) 2015-039936

(51) Int. Cl. G01N 1/34; B01L 3/00

(52) U.S. Cl. CPC G01N 1/34; B01L 3/502; B01L 2200/0631; B01L 2300/0832; B01L 2300/042; B01L 2400/0487; B01L 2300/12

(57) ABSTRACT

A biologically relevant material purification cartridge includes: a syringe which has a first portion and a second portion with a smaller inner diameter than that of the first portion; a plunger which has a cylindrical section capable of being fitted to an inner peripheral surface of the first portion and a rod-shaped section supported by the cylindrical section and capable of being fitted to an inner peripheral surface of the second portion, and can be inserted from the side of the first portion of the syringe, and can move in the insertion direction with respect to the syringe; and a cap which has a vent hole for communicating the internal space of the cylindrical section with the outside and a breathable sheet disposed to close the vent hole, and is connected to the cylindrical section.

### BACKGROUND

1. Technical Field

The present invention relates to a container, a biologically relevant material purification cartridge, and a biologically relevant material purification cartridge assembly kit.

2. Related Art

In the field of biochemistry, a technique of PCR (Polymerase Chain Reaction) has been established. Recently, amplification accuracy and detection sensitivity in PCR have been improved, and it has become possible to amplify an extremely small amount of a sample (DNA or the like) and to perform detection and analysis. The PCR is a method for amplifying a target nucleic acid by subjecting a solution (reaction mixture) containing a nucleic acid (target nucleic acid) to be amplified and a reagent to thermal cycling. As the thermal cycling in PCR, a method for performing thermal cycling at two temperatures or three temperatures is generally used.

On the other hand, the diagnosis of an infectious disease such as influenza in the medical practice is currently performed mainly by using a simple test kit such as an immunochromatograph. However, in such a simple test, accuracy is sometimes insufficient, and it has been desired to apply PCR which can be expected to provide higher test accuracy to the diagnosis of an infectious disease. Further, in general outpatient practice in a medical institution, because the consultation time is limited, the time that can be spent for testing is limited to a short time. Due to this, the current situation is that, for example, the test for influenza is performed by a simple test using an immunochromatograph or the like in a shorter time at the sacrifice of test accuracy. Further, in quarantine at airports or the like, it is necessary to obtain results quickly, and therefore, it has been desired to accelerate PCR.

In response to such a demand, for example, JP-A-2014-176304 (PTL 1) has proposed a cartridge for amplifying a nucleic acid. The cartridge described in PTL 1 tries to consistently perform a procedure from introduction of a sample to an amplification reaction of a nucleic acid in one cartridge. Specifically, a sample containing a nucleic acid is continuously extracted and purified in a pretreatment section, and the nuclei acid is eluted into an eluent. Then, the eluent containing the nucleic acid is pushed out into a nucleic acid amplification reaction container with a plunger, and a nucleic acid amplification reaction is performed successively.

In order to consistently perform the procedure from introduction of a sample to an amplification reaction of a nucleic acid, the cartridge described in PTL 1 adopts a method in which a cylindrical section and a rod-shaped section are provided in a plunger, and the rod-shaped section is inserted into a syringe, thereby pushing out an eluent into a nucleic acid amplification reaction container.

The cartridge described in PTL 1 is configured such that the internal volume of the cartridge is changed by the movement of the plunger. However, the measures for the change in the internal pressure due to the change in the internal volume of the cartridge were not always sufficient. For example, in the cartridge described in PTL 1, when the plunger was pushed in, the internal pressure was increased, and as a result, the eluent was sometimes pushed out into the nucleic acid amplification reaction container earlier than a predetermined time.

Further, in the operation of the cartridge, in the case where an act of withdrawing the plunger is included, the internal pressure is decreased by the change in the internal volume of the cartridge, however, also in such a case, there is a concern that a liquid plug may move to an unintended position due to a decrease in the internal pressure.

Here, in order to suppress the change in the internal pressure of the cartridge to be small, it is considered to be effective to provide an appropriate vent hole. However, in the case where various types of liquids are present in the cartridge, leakage or the like of the liquids in the cartridge is liable to occur merely by providing the vent hole.

### SUMMARY

An advantage of some aspects of the invention is to provide a biologically relevant material purification cartridge capable of suppressing the change in the pressure in the cartridge to be small even when a plunger moves, and also capable of suppressing the leakage of a liquid in the cartridge.

The invention can be implemented as the following forms or application examples.

### Application Example 1

A biologically relevant material purification cartridge according to an aspect of the invention includes: a syringe which has a first portion and a second portion with a smaller inner diameter than that of the first portion; a plunger which has a cylindrical section capable of being fitted to an inner peripheral surface of the first portion and a rod-shaped section supported by the cylindrical section and capable of being fitted to an inner peripheral surface of the second portion, and can be inserted from the side of the first portion of the syringe, and can move in the insertion direction with respect to the syringe; and a cap which has a vent hole for communicating the internal space of the cylindrical section with the outside and a breathable sheet disposed to close the vent hole, and is connected to the cylindrical section.

In the biologically relevant material purification cartridge according to this application example, even if the internal volume is changed by moving the plunger in a capped state in the syringe, a gas can flow to and from the outside through the vent hole, and thus, the change in the pressure in the cartridge can be suppressed to be small. Further, in the biologically relevant material purification cartridge according to Application Example 1, even when a liquid is present in the plunger, the leakage of the liquid in the cartridge can be suppressed by the breathable sheet.

### Application Example 2

In the biologically relevant material purification cartridge according to Application Example 1, the sheet may contain a water-repellent material.

According to such a biologically relevant material purification cartridge, even if a liquid comes in contact with the sheet, the breathability can be favorable maintained.

### Application Example 3

In the biologically relevant material purification cartridge according to Application Example 1 or 2, a liquid may be disposed inside the cylindrical section.

According to such a biologically relevant material purification cartridge, a biologically relevant material can be efficiently purified.

### Application Example 4

In the biologically relevant material purification cartridge according to any one of Application Examples 1 to 3, a mesh may be disposed on the vent hole of the cap, and the mesh may be disposed on the side of the internal space of the plunger closer than the sheet.

According to such a biologically relevant material purification cartridge, even if a liquid is present in the plunger, the liquid is less likely to come in contact with the sheet, and thus, the breathability can be more favorable maintained.

### Application Example 5

In the biologically relevant material purification cartridge according to any one of Application Examples 1 to 4, the cartridge may include an adsorption container which seals and holds an adsorption liquid for adsorbing a biologically relevant material onto a material binding solid phase carrier and a fluid immiscible with the adsorption liquid, and an elution container which seals and holds an eluent for eluting the biologically relevant material from the material binding solid phase carrier and a fluid immiscible with the eluent, and the adsorption container may include the syringe, the plunger, and the cap.

According to such a biologically relevant material purification cartridge, it is possible to at least prevent the eluent from being discharged at an unintended time, and therefore, a biologically relevant material can be stably and efficiently purified.

### BRIEF DESCRIPTION OF THE DRAWINGS

The invention will be described with reference to the accompanying drawings, wherein like numbers reference like elements.

FIG. 1 is a front view of a container assembly 1 according to an embodiment.

FIG. 2 is a side view of the container assembly 1 according to the embodiment.

FIG. 3 is a plan view of the container assembly 1 according to the embodiment.

FIG. 4 is a perspective view of the container assembly 1 according to the embodiment.

FIG. 5 is a cross-sectional view of the container assembly 1 according to the embodiment taken along the line A-A in FIG. 3.

FIG. 6 is a cross-sectional view of the container assembly 1 according to the embodiment taken along the line C-C in FIG. 3.

FIGS. 7A and 7B are schematic views for illustrating the operation of the container assembly 1 according to the embodiment.

FIGS. 8A and 8B are schematic views for illustrating the operation of the container assembly 1 according to the embodiment.

FIG. 9 is a schematic structural view of a PCR device 50.

FIG. 10 is a block diagram of the PCR device 50.

FIG. 11 is a cross-sectional view of the container assembly 1 according to the embodiment.

FIG. 12 is a cross-sectional view of a syringe section 120 according to the embodiment.

FIG. 13 is a plan view of a plunger section 130 according to the embodiment.

FIG. 14 is a cross-sectional view of the plunger section 130 according to the embodiment.

FIGS. 15A to 15E are enlarged views of a cap 110 according to the embodiment.

FIG. 16 is a view for illustrating the movement of the plunger according to the embodiment.

FIG. 17 is a view for illustrating the movement of the plunger according to the embodiment.

### DESCRIPTION OF EXEMPLARY EMBODIMENTS

Hereinafter, preferred embodiments of the invention will be described in detail with reference to the accompanying drawings. It is noted that the embodiments described below do not unduly limit the content of the invention described in the scope of the appended claims. Also, all of the configurations described below are not necessarily essential components of the invention.

A biologically relevant material purification cartridge (container assembly) according to the invention is a cartridge for performing PCR and purifies a biologically relevant material. Here, the biologically relevant material is a material relevant to a living body, and examples thereof include biopolymers such as nucleic acids (DNA and RNA), polypeptides, proteins, and polysaccharides, and biogenic low-molecular organic compounds and inorganic compounds such as proteins, enzymes, peptides, nucleotides, amino acids, and vitamins. In the following embodiments, a description will be made using a nucleic acid as the biologically relevant material by way of example.

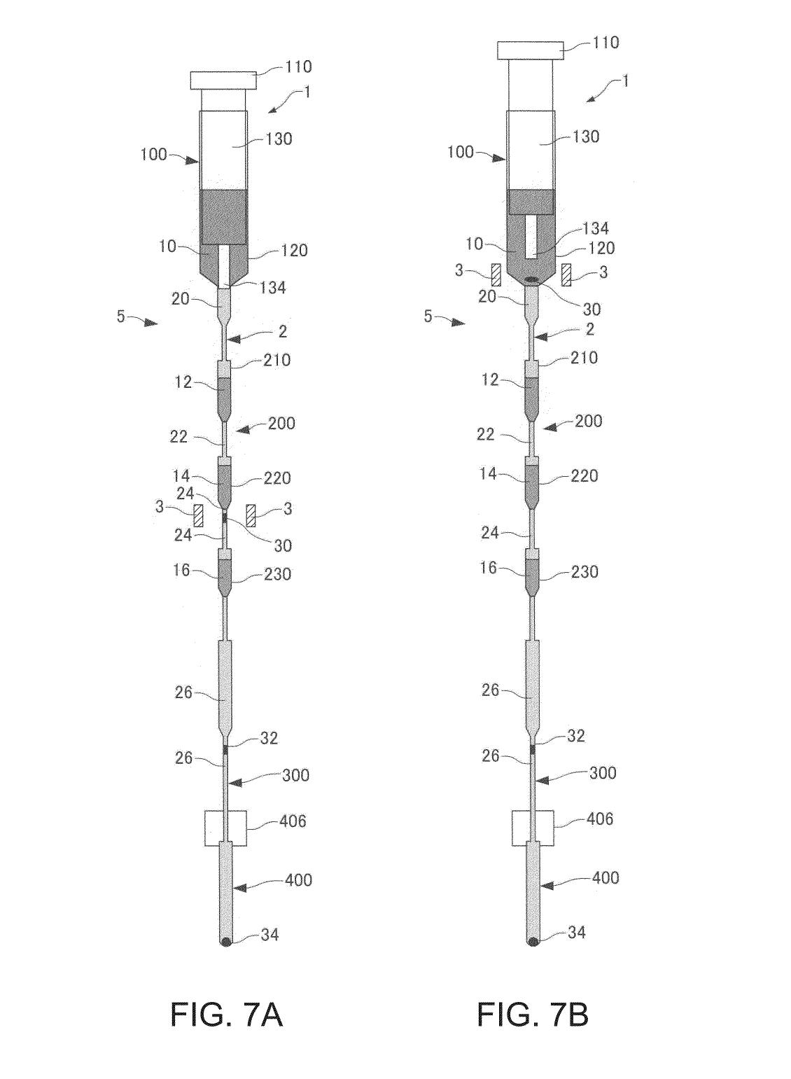

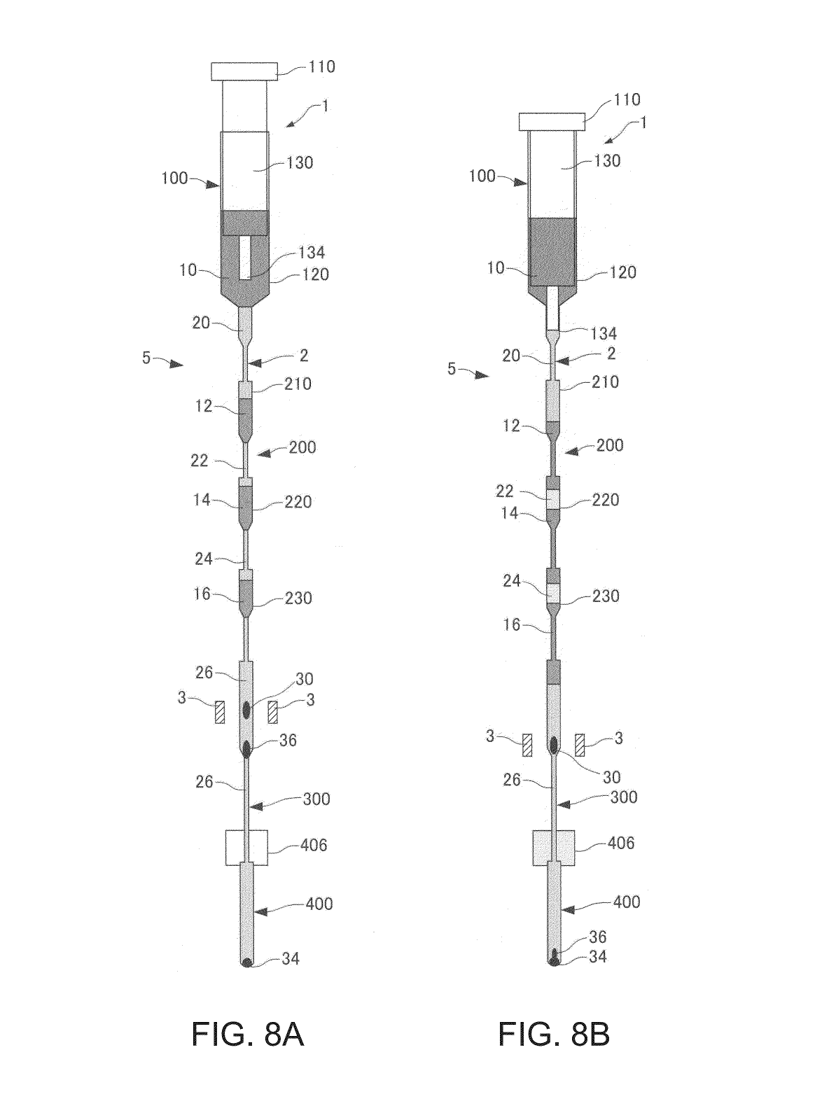

The biologically relevant material purification cartridge according to the invention may include a material binding solid phase carrier on which a biologically relevant material is adsorbed. Here, the material binding solid phase carrier is a material capable of adsorbing a biologically relevant material, that is, capable of holding a biologically relevant material through a reversible physical bond. The shape of the material binding solid phase carrier is preferably fine particles, but is not limited thereto, and may be fine fibers or a net-like body, but is not particularly limited thereto. The material binding solid phase carrier preferably has a magnetism for moving the material binding solid phase carrier in a desired direction in the container assembly while adsorbing a biologically relevant material thereon. In the following embodiments, a description will be made using magnetic beads 30 (see FIGS. 7A to 8B described below) which adsorb a nucleic acid as the material binding solid phase carrier.

The biologically relevant material purification cartridge (container assembly 1) according to the embodiment has a feature that it includes: a syringe which has a first portion and a second portion with a smaller inner diameter than that of the first portion; a plunger which has a cylindrical section capable of being fitted to an inner peripheral surface of the first portion and a rod-shaped section supported by the cylindrical section and capable of being fitted to an inner peripheral surface of the second portion, and can be inserted from the side of the first portion of the syringe, and can move in the insertion direction with respect to the syringe; and a cap which has a vent hole for communicating the internal space of the cylindrical section of the plunger with the outside and a breathable sheet disposed to close the vent hole, and is connected to the cylindrical section of the plunger.

Further, the biologically relevant material purification cartridge (container assembly 1) of the embodiment may include an adsorption container which includes the syringe, the plunger, and the cap, and seals and holds an adsorption liquid for adsorbing a biologically relevant material onto a material binding solid phase carrier and a fluid immiscible with the adsorption liquid, and an elution container which seals and holds an eluent for eluting the biologically relevant material from the material binding solid phase carrier and a fluid immiscible with the eluent.

### 1. Outline of Container Assembly

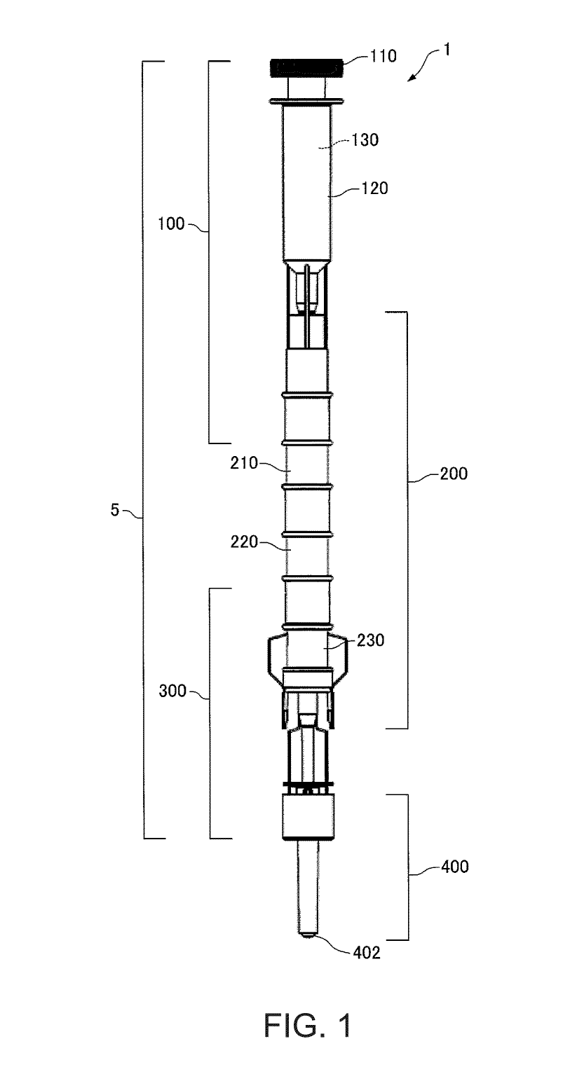

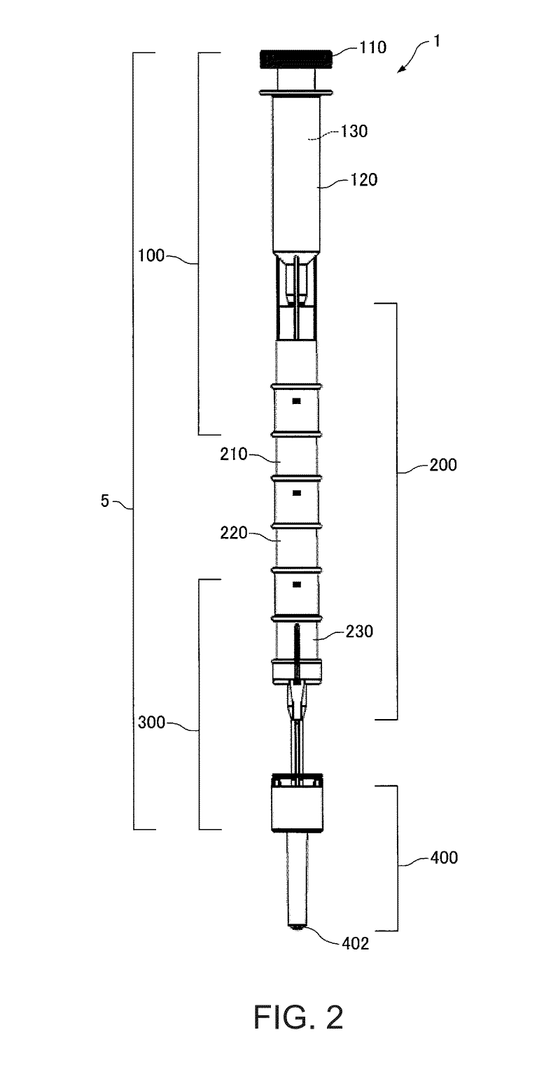

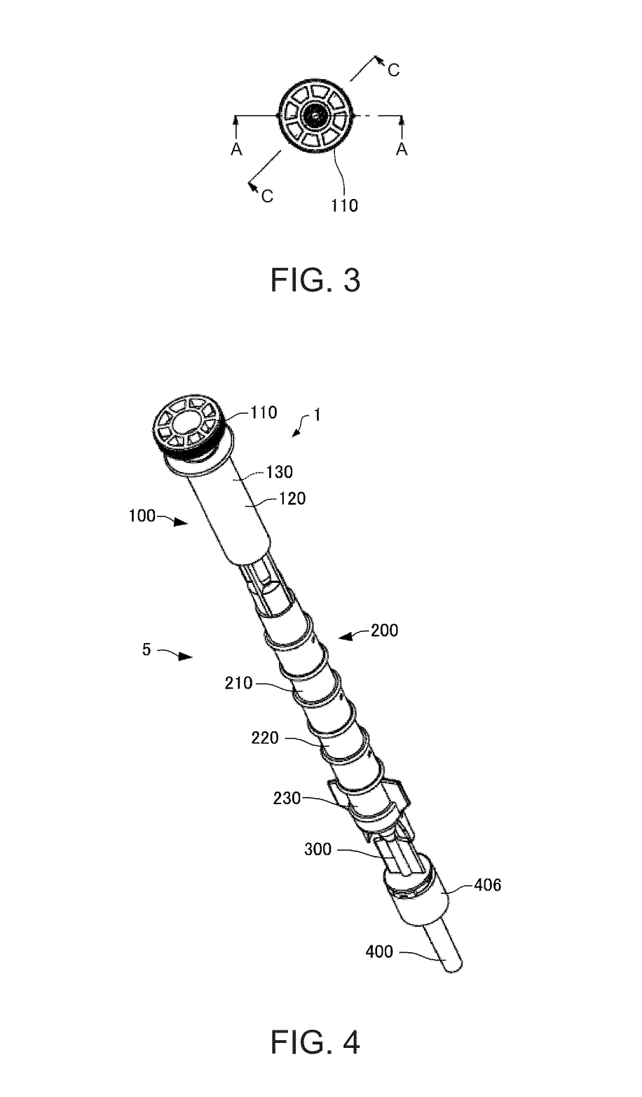

First, the outline of the container assembly 1 according to the embodiment will be described with reference to FIGS. 1 to 4. FIG. 1 is a front view of the container assembly 1 (hereinafter sometimes referred to as “cartridge”) according to the embodiment. FIG. 2 is a side view of the container assembly 1 according to the embodiment. FIG. 3 is a plan view of the container assembly 1 according to the embodiment. FIG. 4 is a perspective view of the container assembly 1 according to the embodiment. Incidentally, a description will be made by assuming that the state of the container assembly 1 in FIGS. 1 to 3 is an erected state.

The container assembly 1 includes an adsorption container 100, a washing container 200, an elution container 300, and a reaction container 400. The container assembly 1 is a container which forms a flow path (not shown) communicating from the adsorption container 100 to the reaction container 400. The flow path of the container assembly 1 is closed at one end with a cap 110 and closed at the other end with a bottom section 402.

The container assembly 1 is a container for performing a pretreatment in which a nucleic acid is bound to magnetic beads (not shown) in the adsorption container 100 and purified while the magnetic beads are moving in the washing container 200, and then, the nucleic acid is eluted into a liquid droplet of an eluent (not shown) in the elution container 300, and a thermal cycling treatment in which a polymerase reaction is performed for the liquid droplet of the eluent containing the nucleic acid in the reaction container 400.

The material of the container assembly 1 is not particularly limited, however, for example, a glass, a polymer, a metal, or the like can be used. When a material which is transparent for visible light such as a glass or a polymer is selected as the material of the container assembly 1, the internal portion (internal hollow space) can be observed from the outside of the container assembly 1, and therefore, such a material is more preferred. Further, when a material through which a magnetic force is transmitted or a non-magnetic material is selected as the material of the container assembly 1, in the case where magnetic beads (not shown) are allowed to pass through the container assembly 1, and so on, by applying a magnetic force from the outside of the container assembly 1, this can be easily performed, and thus, such a material is preferred. As the material of the container assembly 1, for example, a polypropylene resin can be used.

The adsorption container 100 includes a syringe section 120 which has a cylindrical shape and holds an adsorption liquid (not shown) therein, a plunger section 130 which is a movable pusher inserted into the syringe section 120, and a cap 110 which is fixed to one end of the plunger section 130. The adsorption container 100 can push out the adsorption liquid (not shown) held in the syringe section 120 into the washing container 200 by moving the cap 110 with respect to the syringe section 120 to slide the plunger section 130 along the inner surface of the syringe section 120. The adsorption liquid will be described later.

The washing container 200 is obtained by joining and assembling first to third washing containers 210, 220, and 230 to one another. Each of the first to third washing containers 210, 220, and 230 has one or more washing liquid layers partitioned by an oil layer (not shown) therein. By joining the first to third washing containers 210, 220, and 230 to one another, the washing container 200 includes a plurality of washing liquid layers partitioned by a plurality of oil layers (not shown) therein. The washing container 200 of the embodiment has been described by showing an example using three washing containers including the first to third washing containers 210, 220, and 230, but is not limited thereto, and the number of the containers can be appropriately increased or decreased according to the number of washing liquid layers. The washing liquid will be described later.

The elution container 300 is joined to the third washing container 230 of the washing container 200 and holds an eluent therein such that the shape of a plug can be maintained. Here, the “plug” refers to a liquid in the case where a specific liquid makes up one division in the flow path. More specifically, the plug of a specific liquid refers to a columnar material made up substantially only of the specific liquid, and shows a state where a given space in the flow path is partitioned by the liquid plug in the longitudinal direction of the flow path. Here, the expression “substantially” refers to that another material (a liquid or the like) may be present in a small amount (for example, in the shape of a thin film) on the periphery of the plug, that is, on the inner wall of the flow path. The eluent will be described later.

A nucleic acid purification device 5 includes the adsorption container 100, the washing container 200, and the elution container 300.

The reaction container 400 is a container which is joined to the elution container 300 and receives a liquid pushed out from the elution container 300, and also is a container which holds a liquid droplet of an eluent containing a sample at the time of a thermal cycling treatment. Further, the reaction container 400 holds a reagent (not shown). The reagent will be described later.

### 2. Detailed Structure of Container Assembly

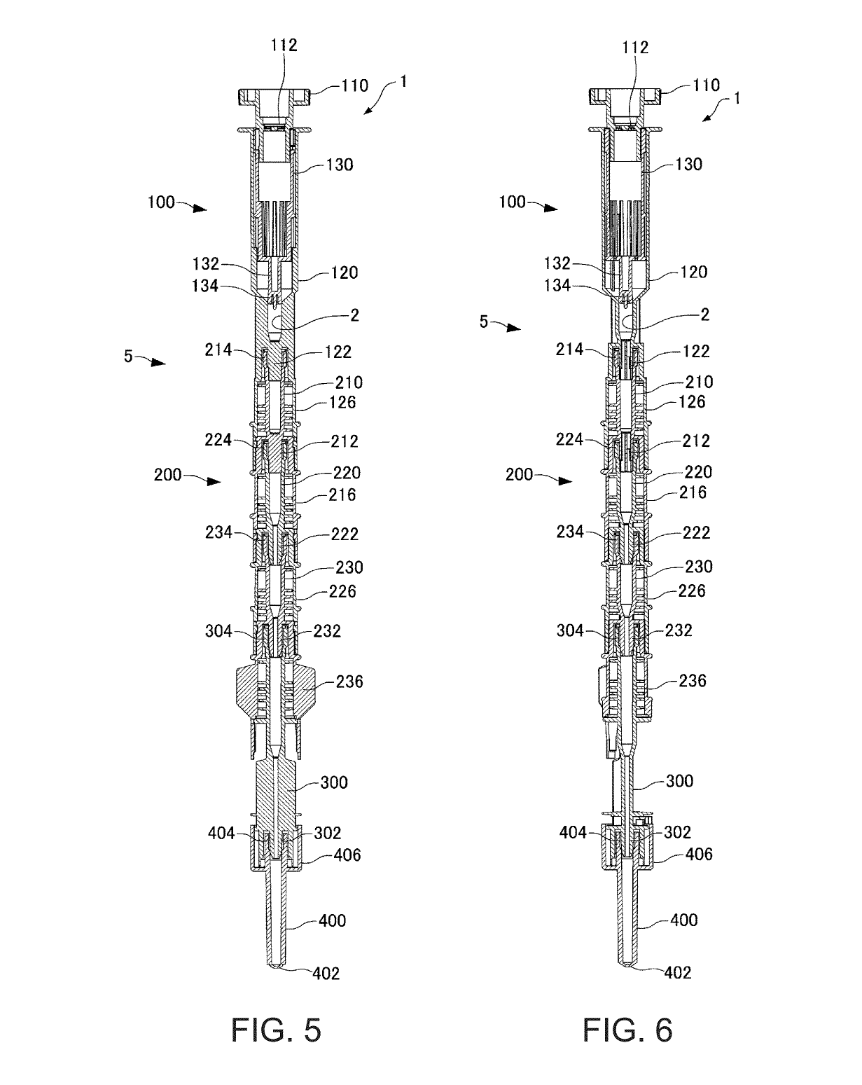

Next, a detailed structure of the container assembly 1 will be described with reference to FIGS. 5 and 6. FIG. 5 is a cross-sectional view of the container assembly 1 according to the embodiment taken along the line A-A in FIG. 3. FIG. 6 is a cross-sectional view of the container assembly 1 according to the embodiment taken along the line C-C in FIG. 3. Incidentally, in fact, the container assembly 1 is assembled in a state where the content such as a washing liquid or the like is charged, however, in FIGS. 5 and 6, in order to describe the structure of the container assembly 1, the illustration of the content is omitted.

### 2-1. Adsorption Container

In the adsorption container 100, the plunger section 130 is inserted from one opening end section of the syringe section 120, and the cap 110 is inserted into an opening end section of the plunger section 130. The cap 110 has a vent section 112 in the center thereof, and can suppress the change in the internal pressure of the plunger section 130 by the vent section 112 when operating the plunger section 130.

The plunger section 130 is a pusher, which has a substantially cylindrical shape and slides along the inner peripheral surface of the syringe section 120, and includes an opening end section into which the cap 110 is inserted, a rod-shaped section 132 which extends in the longitudinal direction of the syringe section 120 from the bottom section facing the opening end section, and a tip section 134 which is the tip of the rod-shaped section 132. The rod-shaped section 132 protrudes from the center of the bottom section of the plunger section 130, and a through-hole is formed around the rod-shaped section 132, and the inside of the plunger section 130 and the inside of the syringe section 120 communicate with each other.

The syringe section 120 constitutes a part of the flow path 2 of the container assembly 1, and includes a large-diameter section which houses the plunger section 130, a small-diameter section which has a smaller inner diameter than that of the large-diameter section, a reduced-diameter section in which the inner diameter is reduced from that of the large-diameter section to that of the small-diameter section, an adsorption insertion section 122 at the tip of the small-diameter section, and an adsorption cover section 126 which has a cylindrical shape and covers the periphery of the adsorption insertion section 122. Each of the large-diameter section, the small-diameter section, and the adsorption insertion section 122 constituting a part of the flow path 2 of the container assembly 1 has a substantially cylindrical shape.

The tip section 134 of the plunger section 130 seals the small-diameter section of the syringe section 120 and separates the large-diameter section and the reduced-diameter section from the small-diameter section to form two divisions when the container assembly is provided to an operator.

The adsorption insertion section 122 of the syringe section 120 is inserted into a first receiving section 214 which is one opening end section of the first washing container 210 in the washing container 200 and fitted thereto, whereby the syringe section 120 and the first washing container 210 are joined to each other. The outer peripheral surface of the adsorption insertion section 122 and the inner peripheral surface of the first receiving section 214 come in close contact with each other to prevent the leakage of a liquid which is the content to the outside.

### 2-2. Washing Container

The washing container 200 constitutes a part of the flow path 2 of the container assembly 1, and is an assembly composed of the first to third washing containers 210, 220, and 230. The basic structures of the first to third washing containers 210, 220, and 230 are the same, and therefore, the structure of the first washing container 210 will be described, and the description of the second and third washing containers 220 and 230 will be omitted.

The first washing container 210 has a substantially cylindrical shape extending in the longitudinal direction of the container assembly 1, and includes a first insertion section 212 formed in one opening end section, the first receiving section 214 formed in the other opening end section, and a first cover section 216 which has a cylindrical shape and covers the periphery of the first insertion section 212.

The outer diameter of the first insertion section 212 and the inner diameter of a second receiving section 224 are substantially the same. Further, the inner diameter of the first receiving section 214 and the outer diameter of the adsorption insertion section 122 are substantially the same.

The first insertion section 212 of the first washing container 210 is inserted into the second receiving section 224 of the second washing container 220 and fitted thereto, whereby the outer periphery of the first insertion section 212 and the inner periphery of the second receiving section 224 come in close contact with each other to achieve sealing, and also the first washing container 210 and the second washing container 220 are joined to each other. In the same manner, the first to third washing containers 210, 220, and 230 are connected to one another to form the washing container 200. Here, the phrase “achieve sealing” refers to that sealing is performed so that at least a liquid or a gas held in the container or the like does not leak to the outside, and may include that sealing is performed so that a liquid or a gas does not enter from the outside to the inside.

### 2-3. Elution Container

The elution container 300 has a substantially cylindrical shape extending in the longitudinal direction of the container assembly 1, and constitutes a part of the flow path 2 of the container assembly 1. The elution container 300 includes an elution insertion section 302 formed in one opening end section and an elution receiving section 304 formed in the other opening end section.

The inner diameter of the elution receiving section 304 and the outer diameter of a third insertion section 232 of the third washing container 230 are substantially the same. The third insertion section 232 is inserted into the elution receiving section 304 and fitted thereto, whereby the outer periphery of the third insertion section 232 and the inner periphery of the elution receiving section 304 come in close contact with each other to achieve sealing, and also the third washing container 230 and the elution container 300 are joined to each other.

### 2-4. Reaction Container

The reaction container 400 has a substantially cylindrical shape extending in the longitudinal direction of the container assembly 1, and constitutes a part of the flow path 2 of the container assembly 1. The reaction container 400 includes a reaction receiving section 404 formed in the opening end section, the bottom section 402 formed at the other closed end section, and a reservoir section 406 which covers the reaction receiving section 404.

The inner diameter of the reaction receiving section 404 and the outer diameter of an elution insertion section 302 of the elution container 300 are substantially the same. The elution insertion section 302 is inserted into the reaction receiving section 404 and fitted thereto, whereby the elution container 300 and the reaction container 400 are joined to each other.

The reservoir section 406 having a predetermined space is provided around the reaction receiving section 404. The reservoir section 406 has a volume capable of receiving a liquid overflowing from the reaction container 400 by moving the plunger section 130.

### 3. Content of Container Assembly and Operation of Container Assembly

Next, the content of the container assembly 1 will be described with reference to FIG. 7A, and the operation of the container assembly 1 will be described with reference to FIGS. 7A to 8B. FIGS. 7A and 7B are schematic views for illustrating the operation of the container assembly 1 according to the embodiment. FIGS. 8A and 8B are schematic views for illustrating the operation of the container assembly 1 according to the embodiment. Incidentally, in FIGS. 7A to 8B, in order to describe the state of the content, the respective containers are expressed as the flow path 2, and the outer shapes and the joint structures are omitted.

### 3-1. Content

FIG. 7A shows the state of the content in the flow path 2 in the state shown in FIG. 1. The content in the flow path 2 is an adsorption liquid 10, a first oil 20, a first washing liquid 12, a second oil 22, a second washing liquid 14, a third oil 24, magnetic beads 30, the third oil 24, a third washing liquid 16, a fourth oil 26, an eluent 32, the fourth oil 26, and a reagent 34 in this order from the cap 110 side to the reaction container 400 side.

In the flow path 2, a portion (a thick portion of the flow path 2) having a large cross-sectional area orthogonal to the longitudinal direction of the container assembly 1 and a portion (a thin portion of the flow path 2) having a small cross-sectional area orthogonal to the longitudinal direction of the container assembly 1 are alternately disposed. Each of the first to fourth oils 20, 22, 24, and 26 and the eluent 32 is partially or entirely held in the thin portion of the flow path 2. In the case where the interface between the adjacent liquids (The liquids may be fluids. The same shall apply hereinafter), which are immiscible with each other, is disposed in the thin portion of the flow path 2, the cross-sectional area of the thin portion of the flow path 2 has an area capable of stably maintaining the interface. Therefore, by the liquid disposed in the thin portion of the flow path 2, the positional relationship between the liquid and the other liquids disposed on the upper and lower sides of the liquid can be stably maintained. Further, even in the case where the interface between the liquid disposed in the thin portion of the flow path 2 and another liquid disposed in the thick portion of the flow path 2 is formed in the thick portion of the flow path 2, even if the interface is disrupted by a strong impact, the interface is stably formed at a predetermined position by leaving the container assembly to stand.

The thin portion of the flow path 2 is formed inside the adsorption insertion section 122, the first insertion section 212, the second insertion section 222, the third insertion section 232, and the elution insertion section 302, and also extends upward above the elution insertion section 302 in the elution container 300. Incidentally, the liquid held in the thin portion of the flow path 2 is stably maintained even before the container is assembled.

### 3-1-1. Oil

The first to fourth oils 20, 22, 24, and 26 are each composed of an oil, and are each present as a plug between the liquids disposed on the upper and lower sides of each oil in the state shown in FIGS. 7A and 7B. Since the first to fourth oils 20, 22, 24, and 26 are each present as a plug, as the adjacent liquids disposed on the upper and lower sides of each oil, liquids which are phase-separated from the oil, that is, liquids which are immiscible with the oil are selected. Further, the oils constituting the first to fourth oils 20, 22, 24, and 26 may be different types of oils. As the oil which can be used for these oils, for example, one type selected from silicone-based oils such as dimethylsilicone oil, paraffin-based oils, mineral oils, and mixtures thereof can be used.

### 3-1-2. Adsorption Liquid

The adsorption liquid 10 refers to a liquid in which a nucleic acid is adsorbed onto the magnetic beads 30, and is, for example, an aqueous solution containing a chaotropic substance. As the adsorption liquid 10, for example, a liquid containing 5 M guanidine thiocyanate, 2% Triton X-100, and 50 mM Tris-HCl (pH 7.2) can be used. The adsorption liquid 10 is not particularly limited as long as it contains a chaotropic substance, but may contain a surfactant for the purpose of disrupting cell membranes or denaturing proteins contained in cells. This surfactant is not particularly limited as long as it is generally used for extracting nucleic acids from cells or the like. Specific examples thereof include nonionic surfactants such as Triton surfactants (such as Triton-X) and Tween surfactants (such as Tween 20) and anionic surfactants such as sodium N-lauroylsarcosinate (SLS). However, particularly, it is preferred to use a nonionic surfactant in an amount ranging from 0.1 to 2%. Further, the adsorption liquid preferably contains a reducing agent such as 2-mercaptoethanol or dithiothreitol. The adsorption liquid may be a buffer, but preferably has a neutral pH ranging from 6 to 8. In light of this, specifically, the adsorption liquid preferably contains a guanidine salt (3 to 7 M), a nonionic surfactant (0 to 5%), EDTA (0 to 0.2 mM), a reducing agent (0 to 0.2 M), and the like.

The chaotropic substance is not particularly limited as long as it generates a chaotropic ion (a monovalent anion having a large ionic radius) in an aqueous solution, has an activity to increase the water solubility of a hydrophobic molecule, and contributes to the adsorption of a nucleic acid onto the solid phase carrier. Specific examples thereof include guanidine thiocyanate, guanidine hydrochloride, sodium iodide, and sodium perchlorate. Among these, guanidine thiocyanate or guanidine hydrochloride having a high protein denaturation activity is preferred. The concentration of such a chaotropic substance varies depending on the respective substances, and for example, when guanidine thiocyanate is used, the concentration thereof is preferably in the range of 3 to 5.5 M, and when guanidine hydrochloride is used, the concentration thereof is preferably 5 M or more.

By the presence of the chaotropic substance in the aqueous solution, the nucleic acid in the aqueous solution is more thermodynamically advantageous when it is present in a state of being adsorbed onto a solid than when it is present in a state of being surrounded by water molecules, and therefore is adsorbed onto the surfaces of the magnetic beads 30.

### 3-1-3. Washing Liquid

The first to third washing liquids 12, 14, and 16 are liquids for washing the magnetic beads 30 having a nucleic acid bound thereto.

The first washing liquid 12 is a liquid which is phase-separated from both of the first oil 20 and the second oil 22. The first washing liquid 12 is preferably water or a low-salt concentration aqueous solution, and in the case of a low-salt concentration aqueous solution, the low-salt concentration aqueous solution is preferably a buffer. The salt concentration in the low-salt concentration aqueous solution is preferably 100 mM or less, more preferably 50 mM or less, and most preferably 10 mM or less. The first washing liquid 12 may contain a surfactant as described above, and the pH thereof is not particularly limited. The salt for forming the first washing liquid 12 as a buffer is not particularly limited, however, a salt such as Tris, HEPES, PIPES, or a phosphate is preferably used. Further, the first washing liquid 12 preferably contains an alcohol only in such an amount that it does not inhibit the adsorption of a nucleic acid onto a carrier, a reverse transcription reaction, a PCR reaction, and the like. In such a case, the concentration of the alcohol is not particularly limited.

The first washing liquid 12 may contain a chaotropic substance. By including, for example, guanidine hydrochloride in the first washing liquid 12, the magnetic beads 30 or the like can be washed while maintaining or enhancing the adsorption of a nucleic acid adsorbed onto the magnetic beads 30 or the like.

The second washing liquid 14 is a liquid which is phase-separated from both of the second oil 22 and the third oil 24. The second washing liquid 14 may basically have a composition which is the same as or different from that of the first washing liquid 12, but is preferably a solution which does not substantially contain a chaotropic substance. This is to eliminate the carry-over of a chaotropic substance to the next solution. The second washing liquid 14 may be composed of, for example, 5 mM Tris hydrochloride buffer. The second washing liquid 14 preferably contains an alcohol as described above.

The third washing liquid 16 is a liquid which is phase-separated from both of the third oil 24 and the fourth oil 26. The third washing liquid 16 may basically have a composition which is the same as or different from that of the second washing liquid 14, but does not contain an alcohol. Further, the third washing liquid 16 can contain citric acid for preventing the carry-over of an alcohol to the reaction container 400.

### 3-1-4. Magnetic Beads

The magnetic beads 30 are beads for adsorbing a nucleic acid, and preferably have a relatively strong magnetism so that the magnetic beads can be moved by a magnet 3 present outside the container assembly 1. The magnetic beads 30 may be, for example, silica beads or silica-coated beads. The magnetic beads 30 may be preferably silica-coated beads.

### 3-1-5. Eluent

The eluent 32 is a liquid which is phase-separated from the fourth oil 26, and is present as a plug sandwiched between the fourth oils 26 and 26 in the flow path 2 in the elution container 300. The eluent 32 is a liquid for eluting a nucleic acid adsorbed onto the magnetic beads 30 in the eluent 32 from the magnetic beads 30. Further, the eluent 32 turns into a liquid droplet in the fourth oil 26 by heating. As the eluent 32, for example, pure water can be used. Here, the “liquid droplet” is a liquid surrounded by a free surface.

### 3-1-6. Reagent

The reagent 34 contains a component necessary for a reaction. In the case where the reaction in the reaction container 400 is PCR, the reagent 34 can contain at least one component selected from an enzyme such as a DNA polymerase and primers (nucleic acids) for amplifying a target nucleic acid (DNA) eluted into a liquid droplet 36 (see FIGS. 8A and 8B) of the eluent, and a fluorescent probe for detecting the amplified product, and here, all of the primers, the enzyme, and the fluorescent probe are contained. The reagent 34 is not compatible with the fourth oil 26, and is dissolved when it comes in contact with the liquid droplet 36 of the eluent 32 containing a nucleic acid to effect a reaction, and is present in a solid state in the lowermost region in the gravitational direction of the flow path 2 in the reaction container 400. For example, as the reagent 34, a lyophilized (freeze-dried) reagent can be used.

### 3-2. Operation of Container Assembly

One example of the operation of the container assembly 1 will be described with reference to FIGS. 7A to 8B.

The operation of the container assembly 1 includes:

(A) a step of assembling the container assembly 1 by joining the adsorption container 100, the washing container 200, the elution container 300, and the reaction container 400;

(B) a step of introducing a sample containing a nucleic acid into the adsorption container 100 holding the adsorption liquid 10;

(C) a step of moving the magnetic beads 30 from the second washing container 220 to the adsorption container 100;

(D) a step of adsorbing the nucleic acid onto the magnetic beads 30 by shaking the adsorption container 100;

(E) a step of moving the magnetic beads 30 having the nucleic acid adsorbed thereon the adsorption container 100 to the elution container 300 through the first oil 20, the first washing liquid 12, the second oil 22, the second washing liquid 14, the third oil 24, the third washing liquid 16, and the fourth oil 26 in this order;

(F) a step of eluting the nucleic acid from the magnetic beads 30 into the eluent 32 in the elution container 300; and

(G) a step of contacting the liquid droplet containing the nucleic acid with the reagent 34 in the reaction container 400.

Hereinafter, the respective steps will be described sequentially.

### (A) Step of Assembling Container Assembly 1

As shown in FIG. 7A, in the assembling step, the container assembly 1 is assembled by joining the containers from the adsorption container 100 to the reaction container 400 to one another to form the flow path 2 in which the containers continue from the adsorption container 100 to the reaction container 400. In FIG. 7A, the cap 110 is attached to the adsorption container 100, however, the cap 110 is attached to the plunger section 130 after the step (B).

More specifically, the elution insertion section 302 of the elution container 300 is inserted into the reaction receiving section 404 of the reaction container 400, the third insertion section 232 of the third washing container 230 is inserted into the elution receiving section 304 of the elution container 300, the second insertion section 222 of the second washing container 220 is inserted into the third receiving section 234 of the third washing container 230, the first insertion section 212 of the first washing container 210 is inserted into the second receiving section 224 of the second washing container 220, and the adsorption insertion section 122 of the adsorption container 100 is inserted into the first receiving section 214 of the first washing container 210.

### (B) Step of Introducing Sample

The introducing step is performed by, for example, inserting a cotton swab with a sample adhered thereto into the adsorption liquid 10 from an opening to which the cap 110 of the adsorption container 100 is attached, and dipping the cotton swab in the adsorption liquid 10. More specifically, the cotton swab is inserted from an opening located at one end of the plunger section 130 in a state of being inserted into the syringe section 120 of the adsorption container 100. Subsequently, the cotton swab is taken out from the adsorption container 100, and the cap 110 is attached. This state is the state shown in FIG. 7A. Further, the sample may be introduced into the adsorption container 100 with a pipette or the like. Further, when the sample is in the form of a paste or a solid, for example, the sample may be adhered to the inner wall of the plunger section 130 or thrown into the adsorption container 100 with a spoon, forceps, or the like. As shown in FIG. 7A, the adsorption liquid 10 is charged to the middle of the syringe section 120 and the plunger section 130, and a space is left on the opening side where the cap 110 is attached.

In the sample, a nucleic acid which becomes a target is contained. Hereinafter, this nucleic acid is sometimes simply referred to as “target nucleic acid”. The target nucleic acid is, for example, DNA (Deoxyribonucleic Acid) or RNA (Ribonucleic Acid). The target nucleic acid is extracted from the sample, and eluted with the eluent 32 described later, and then, utilized as, for example, a template for PCR. Examples of the sample include blood, nasal mucus, oral mucosa, and various types of biological samples.

### (C) Step of Moving Magnetic Beads

The step of moving the magnetic beads 30 is performed by moving the magnet 3 toward the adsorption container 100 in a state where the magnetic force of the magnet 3 disposed outside the container is applied to the magnetic beads 30 present in the form of a plug sandwiched between the third oils 24 and 24 in the second washing container 220 as shown in FIG. 7A.

In accordance with the movement of the magnetic beads 30, or prior thereto, the cap 110 and the plunger section 130 are moved in the direction of withdrawal from the syringe section 120, whereby the sample in the adsorption liquid 10 is moved to the inside of the syringe section 120 from the inside of the plunger section 130. By this movement of the plunger section 130, the flow path 2 closed by the tip section 134 communicates with the adsorption liquid 10.

The magnetic beads 30 go up in the flow path 2 as the magnet 3 moves and reach the inside of the adsorption liquid 10 containing the sample as shown in FIG. 7B.

(D) Step of Adsorbing Nucleic Acid onto Magnetic Beads

The step of adsorbing the nucleic acid is performed by shaking the adsorption container 100. This step can be efficiently performed because the opening of the adsorption container 100 is sealed with the cap 110 so that the adsorption liquid 10 does not leak out. By this step, the target nucleic acid is adsorbed onto the surfaces of the magnetic beads 30 by the action of a chaotropic agent. In this step, a nucleic acid other than the target nucleic acid or a protein may be adsorbed onto the surfaces of the magnetic beads 30.

As a method for shaking the adsorption container 100, a device such as a known vortex shaker may be used, or shaking may be performed by an operator with hand. Further, the adsorption container 100 may be shaken while applying a magnetic field thereto from the outside by utilizing the magnetism of the magnetic beads 30.

### (E) Step of Moving Magnetic Beads Having Nucleic Acid Adsorbed Thereon

In the step of moving the magnetic beads 30 having the nucleic acid adsorbed thereon, the magnetic beads 30 are moved in the adsorption liquid 10, the first to fourth oils 20, 22, 24, and 26, and the first to third washing liquids 12, 14, and 16 by moving the magnet 3 while applying the magnetic force of the magnet 3 thereto from the outside of the adsorption container 100, the washing container 200, and the elution container 300.

As the magnet 3, for example, a permanent magnet, an electromagnet, or the like can be used. Further, the magnet 3 may be moved by an operator with hand or by using a mechanical device or the like. The magnetic beads 30 have a property to be attracted by a magnetic force, and therefore, by utilizing this property, the magnetic beads 30 are moved in the flow path 2 through the adsorption container 100, the washing container 200, and then, the elution container 300 by changing the relative position of the magnet 3. The speed when the magnetic beads 30 pass through the respective washing liquids is not particularly limited, and may be moved reciprocatively along the longitudinal direction of the flow path 2 within the same washing liquid. In the case where the particles or the like other than the magnetic beads 30 are moved in the flow path 2, for example, the particles or the like can be moved by utilizing a gravitational force or a potential difference.

### (F) Step of Eluting Nucleic Acid

In the step of eluting the nucleic acid, the nucleic acid is eluted from the magnetic beads 30 into the liquid droplet 36 of the eluent in the elution container 300. The eluent 32 shown in FIGS. 7A and 7B is present as a plug in the thin portion of the flow path of the elution container 300, however, by heating the reaction container 400 while moving the magnetic beads 30 as described above, the content liquid is expanded, and as shown in FIGS. 8A and 8B, the eluent moves upward in the elution container 300 as the liquid droplet 36. Then, as shown in FIG. 8A, when the magnetic beads 30 reach the liquid droplet 36 of the eluent in the elution container 300, by the action of the eluent, the target nucleic acid adsorbed onto the magnetic beads 30 is eluted into the liquid droplet 36 of the eluent.

(G) Step of Contacting with Reagent 34

In the step of contacting with the reagent 34, the liquid droplet 36 containing the nucleic acid is contacted with the reagent 34 present in the lowermost portion in the reaction container 400. Specifically, as shown in FIG. 8B, the cap 110 is pushed to push down the first oil 20 by the tip section 134 of the plunger section 130, whereby while maintaining the magnetic beads 30 to which the magnetic force of the magnet 3 is applied at a predetermined position, the liquid droplet 36 of the eluent in which the target nucleic acid is eluted is moved into the reaction container 400 and comes in contact with the reagent 34 present in the lowermost portion of the reaction container 400. The reagent 34 with which the liquid droplet 36 comes in contact is dissolved and mixed with the target nucleic acid in the eluent, and for example, PCR using thermal cycling can be performed.

### 4. PCR Device

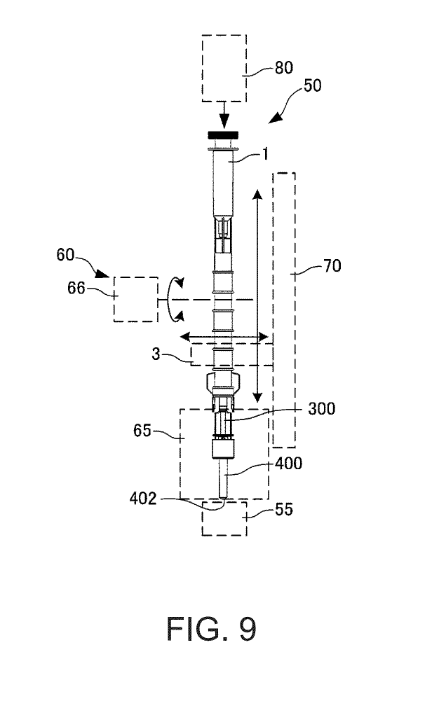

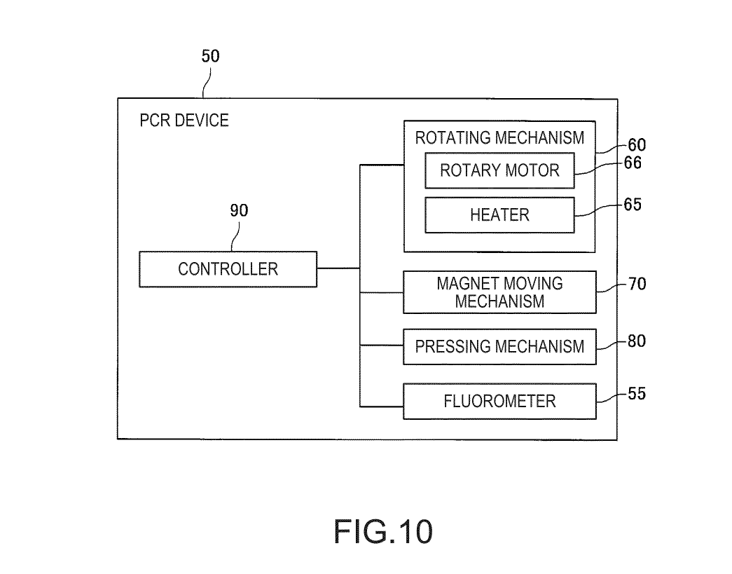

A PCR device 50 which performs a nucleic acid elution treatment and PCR using the container assembly 1 will be described with reference to FIGS. 9 and 10. FIG. 9 is a schematic structural view of the PCR device 50. FIG. 10 is a block diagram of the PCR device 50.

The PCR device 50 includes a rotating mechanism 60, a magnet moving mechanism 70, a pressing mechanism 80, a fluorometer 55, and a controller 90.

### 4-1. Rotating Mechanism

The rotating mechanism 60 includes a rotary motor 66 and a heater 65, and by driving the rotary motor 66, the container assembly 1 and the heater 65 are rotated. By rotating the container assembly 1 and the heater 65 and turning these members upside down by the rotating mechanism 60, the liquid droplet containing the target nucleic acid moves in the flow path of the reaction container 400, whereby a thermal cycling treatment is performed.

The heater 65 includes a plurality of heaters (not shown), and can include, for example, a heater for elution, a heater for high temperature, and a heater for low temperature. The heater for elution heats the eluent in the form of a plug in the container assembly 1, and accelerates the elution of the target nucleic acid from the magnetic beads into the eluent. The heater for high temperature heats the liquid on the upstream side of the flow path of the reaction container 400 to a higher temperature than the heater for low temperature. The heater for low temperature heats the bottom section 402 of the flow path of the reaction container 400. By the heater for high temperature and the heater for low temperature, a temperature gradient can be formed in the liquid in the flow path of the reaction container 400. In the heater 65, a temperature control device is provided, and under the command of the controller 90, the temperature of the liquid in the container assembly 1 can be set to a temperature suitable for the treatment.

The heater 65 has an opening for exposing the outer wall of the bottom section 402 of the reaction container 400. The fluorometer 55 measures the brightness of the liquid droplet of the eluent through the opening.

### 4-2. Magnet Moving Mechanism

The magnet moving mechanism 70 is a mechanism for moving the magnet 3. The magnet moving mechanism 70 moves the magnetic beads in the container assembly 1 by attracting the magnetic beads in the container assembly 1 to the magnet 3, and also moving the magnet 3. The magnet moving mechanism 70 includes a pair of magnets 3, an elevating mechanism, and a swinging mechanism.

The swinging mechanism is a mechanism for swinging the pair of magnets 3 in the horizontal direction in FIG. 9 (the direction may be the front-back direction in FIG. 9). The pair of magnets 3 are disposed to sandwich the container assembly 1 fitted in the PCR device 50 from the left and right sides (see FIGS. 7A to 8B), and in the direction orthogonal to the flow path of the container assembly 1 (here, in the horizontal direction in FIG. 9), a distance between the magnetic beads and the magnet 3 can be made closer. Therefore, by swinging the pair of magnets 3 in the horizontal direction as indicated by the arrow, the magnetic beads in the container assembly 1 move in the horizontal direction in accordance with the movement of the magnets 3. The elevating mechanism can move the magnets 3 in the vertical direction to move the magnetic beads in the horizontal direction in FIG. 9 in accordance with the movement of the magnets 3.

### 4-3. Pressing Mechanism

The pressing mechanism 80 is a mechanism for pressing the plunger section of the container assembly 1, and by pressing the plunger section by the pressing mechanism, the liquid droplet in the elution container 300 is pushed out into the reaction container 400, so that it becomes possible to perform PCR in the reaction container 400.

In FIG. 9, it is shown that the pressing mechanism 80 is disposed on the upper side of the erected container assembly 1, however, the direction in which the pressing mechanism 80 presses the plunger section is not the vertical direction in FIG. 9, but for example, may be tilted by 45° with respect to the vertical direction. According to this, it becomes easy to dispose the pressing mechanism 80 at a position where it does not interfere with the magnet moving mechanism 70.

### 4-4. Fluorometer

The fluorometer 55 is a meter that measures the brightness of the liquid droplet in the reaction container 400. The fluorometer 55 is disposed at a position facing the bottom section 402 of the reaction container 400. It is desirable that the fluorometer 55 can detect the brightness in multiple wavelength ranges so that it can be applied to multiplex PCR.

### 4-5. Controller

The controller 90 is a control section that controls the PCR device 50. The controller 90 includes, for example, a processor such as a CPU and a memory device such as an ROM or an RAM. In the memory device, various programs and data are stored. Further, the memory device provides an area for developing programs. By executing the program stored in the memory device by the processor, various processes are realized.

For example, the controller 90 controls the rotary motor 66 to rotate the container assembly 1 to a predetermined rotational position. In the rotating mechanism 60, a rotational position sensor (not shown) is provided, and the controller 90 drives or stops the rotary motor 66 according to the detection result of the rotational position sensor.

Further, the controller 90 controls the heater 65 to generate heat by the on-off control of the heater, thereby heating the liquid in the container assembly 1 to a predetermined temperature.

Further, the controller 90 controls the magnet moving mechanism 70 to move the magnets 3 in the vertical direction, and swing the magnets 3 in the horizontal direction in FIG. 9 according to the detection result of the position sensor (not shown).

Further, the controller 90 controls the fluorometer 55 to measure the brightness of the liquid droplet in the reaction container 400. This measurement result is stored in the memory device (not shown) of the controller 90.

By fitting the container assembly 1 in this PCR device 50, the steps (C) to (G) described in the above 3-2 can be performed, and further PCR can be performed.

### 5. Detailed Description of Syringe, Plunger, and Cap

The syringe section 120, the plunger section 130, and the cap 110 of the container assembly 1 (hereinafter the same reference numeral is used as “biologically relevant material purification cartridge 1”) according to this embodiment will be described in more detail with reference to the drawings.

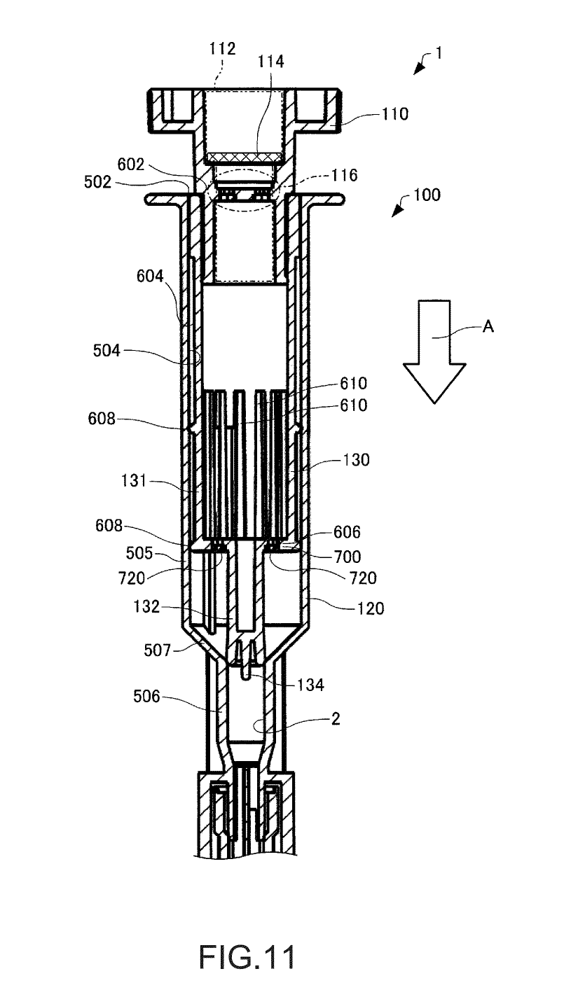

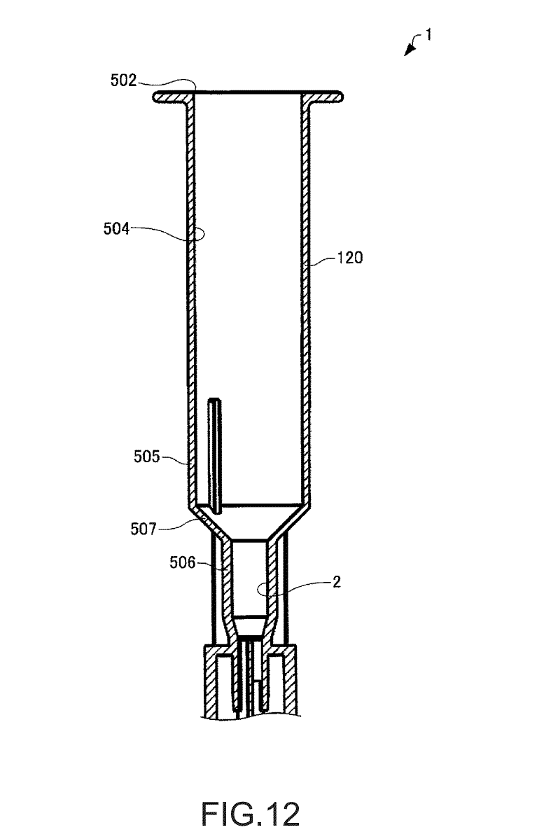

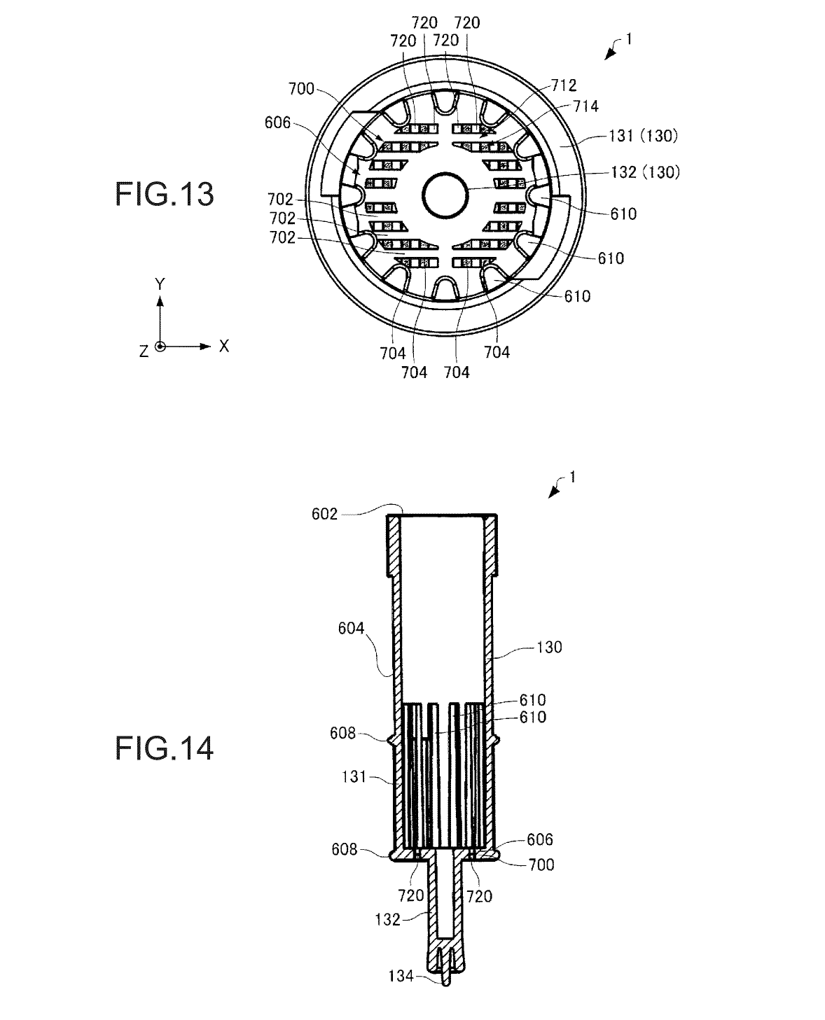

FIG. 11 is a cross-sectional view schematically showing the syringe section 120, the plunger section 130, and the cap 110 according to the embodiment, and is an enlarged view of FIG. 6. FIG. 12 is a cross-sectional view schematically showing the syringe section 120 according to the embodiment, and shows the same cross section as in FIG. 11. FIG. 13 is a plan view schematically showing the plunger section 130 according to the embodiment. FIG. 14 is a cross-sectional view schematically showing the plunger section 130 according to the embodiment, and shows the same cross section as in FIG. 11. Incidentally, in FIG. 11, the illustration of the content in the biologically relevant material purification cartridge 1 is omitted for the sake of convenience. Further, in FIG. 13, x axis, y axis, and z axis are shown as three axes orthogonal to each other.

### 5-1. Syringe

As shown in FIGS. 11 and 12, the syringe section 120 includes an opening end section 502 into which the plunger section 130 is inserted. An inner surface (inner peripheral surface) 504 of the syringe section 120 comes in contact with the plunger section 130. The syringe section 120 includes a first portion (large-diameter section) 505, a second portion (small-diameter section) 506 with a smaller inner diameter than that of the first portion 505, and a third portion (reduced-diameter section) 507 in which the inner diameter is reduced from that of the first portion 505 to that of the second portion 506. The first portion 505 houses a cylindrical section 131 of the plunger section 130. The second portion 506 houses a rod-shaped section 132 of the plunger section 130. The opening end section 502 is provided in the first portion 505.

### 5-2. Plunger

The plunger section 130 can be inserted from the side of the first portion 505 (from the opening end section 502) of the syringe section 120. As shown in FIGS. 11 and 14, the plunger section 130 includes an opening end section 602 into which the cap 110 is inserted. The plunger section 130 includes the cylindrical section 131 and the rod-shaped section 132.

In the cylindrical section 131, the opening end section 602 is provided. The cylindrical section 131 includes an end section (bottom section) 606 facing the opening end section 602. The cylindrical section 131 can be fitted to the inner peripheral surface 504 of the first portion 505 of the syringe section 120. On an outer peripheral surface 604 of the cylindrical section 131, a ring-shaped flange section 608 is provided, and by contacting the flange section 608 with the inner peripheral surface 504 of the syringe section 120, the plunger section 130 is pressed in the syringe section 120. In the example shown in the drawings, two flange sections 608 are provided side by side in the insertion direction A (the direction of the arrow A) of the plunger section 130.

On the inner peripheral surface of the cylindrical section 131, a plurality of protrusions 610 extending in the longitudinal direction of the syringe section 120 (insertion direction A). In the example shown in the drawings, the protrusions 610 extend from the end section 606 to the side of the opening end section 602. The protrusions 610 are disposed, for example, at equal intervals along the inner peripheral surface of the cylindrical section 131.

The rod-shaped section 132 is supported by the end section 606 of the cylindrical section 131 and extends in the insertion direction A. The rod-shaped section 132 can be fitted to the inner peripheral surface 504 of the second portion 506 of the syringe section 120. The rod-shaped section 132 protrudes from the center of the end section 606. In the example shown in the drawings, the rod-shaped section 132 has a hollow structure, and the inside of the rod-shaped section 132 communicates with the inside of the cylindrical section 131.

As shown in FIGS. 11, 13, and 14, a filter 700 is provided in the end section 606 of the cylindrical section 131. In the example shown in the drawings, the filter 700 and the plunger section 130 are integrally formed. The filter 700 and the plunger section 130 may be integrally formed by injection molding. The filter 700 constitutes the end section 606.

As shown in FIG. 13, the filter 700 includes a first structure section 712 including a plurality of first extension sections 702 each extending in the x-axis direction (a first direction) and arranged side by side in the y-axis direction (a second direction orthogonal to the first direction), and a second structure section 714 including a plurality of second extension sections 704 each extending in the y-axis direction and arranged side by side in the x-axis direction. The first structure section 712 and the second structure section 714 are arranged side by side in the insertion direction A (in the example shown in FIG. 13, in the z-axis direction) and connected to each other. The structure sections 712 and 714 are integrally formed. The number of the extension sections 702 and 704 is not particularly limited. The extension sections 702 and 704 may be arranged side by side at equal intervals, or may be arranged side by side at different intervals. The widths of the extension sections 702 and 704 may be equal to or different from each other. The extension sections 702 and 704 are orthogonal to each other when viewed from the insertion direction A (when viewed from the z-axis direction in FIG. 13). The extension sections 702 and 704 are provided in a net-like shape when viewed from the insertion direction A. Incidentally, in FIG. 13, the second extension sections 704 are shown in gray.

In the filter 700, a plurality of through-holes 720 are provided by the extension sections 702 and 704 provided in a net-like shape. The through-holes 720 communicate the inside of the plunger section 130 with the outside. In the example shown in FIG. 13, the through-hole 720 has a quadrangular shape when viewed from the insertion direction A, however, the shape thereof is not particularly limited. The size of the through-hole 720 when viewed from the insertion direction A is, for example, 0.01 mm or more and 1 mm or less, preferably 0.3 mm. By setting the size of the through-hole 720 to 0.01 mm or more, a nucleic acid can be prevented from being trapped by the through-hole 720, and by setting the size of the through-hole 720 to 1 mm or less, contaminants can be prevented from passing therethrough. Incidentally, the “size of the through-hole” is the maximum length of the through-hole, and is the length of the diagonal of the through-hole 720 in the example shown in FIG. 13.

### 5-3. Cap

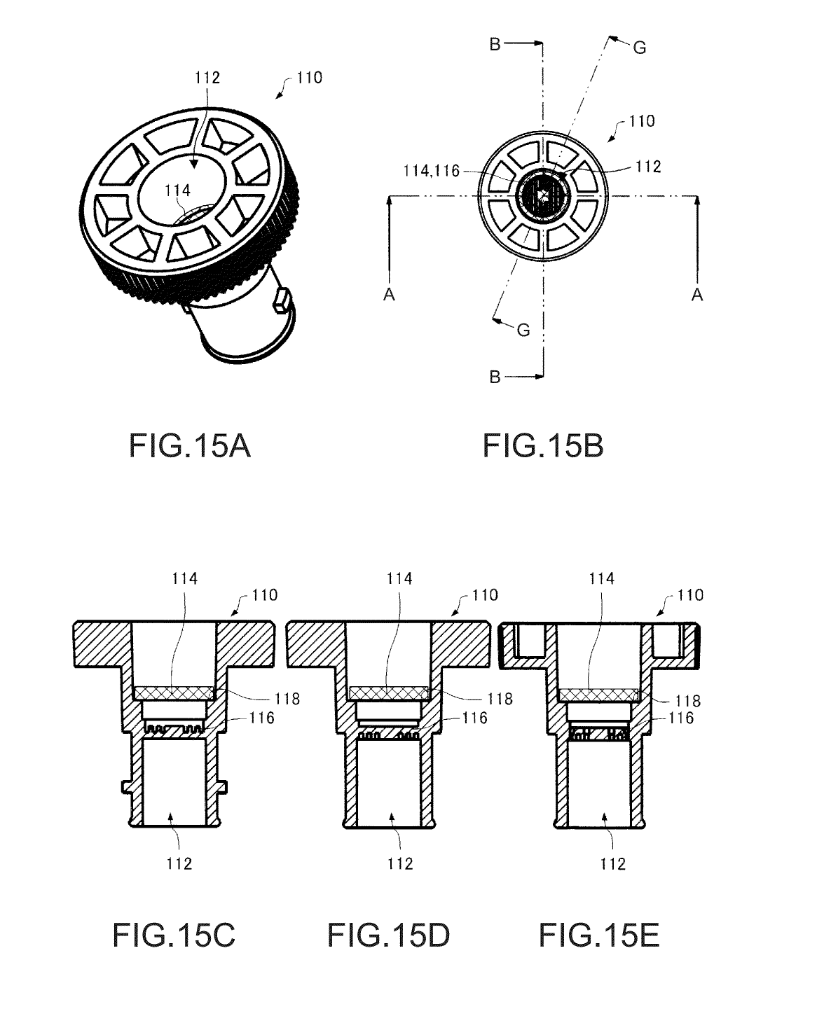

FIGS. 15A to 15E are enlarged schematic views of the cap 110. FIG. 15A is a perspective view schematically showing the cap 110, FIG. 15B is a plan view schematically showing the cap 110, and FIGS. 15C, 15D, and 15E are schematic views of the cross sections taken along the lines A-A, B-B, and G-G in FIG. 15B, respectively.

As shown in FIG. 11, the cap 110 is inserted from the opening end section 502 of the plunger section 130. The cap 110 is slidably engaged with the inner surface of the plunger section 130, and forms an internal hollow space in an internal portion 620 of the plunger section 130.

As shown in FIGS. 15A to 15E, the cap 110 is fitted to the opening end section 602 of the plunger section 130 and attached thereto so as to seal the internal portion 620 of the plunger section 130. The cap 110 inserts the plunger section 130 into the syringe section 120. Alternatively, the cap 110 can function as a handhold (grip) for withdrawing the plunger section 130 from the syringe section 120. The cap 110 is appropriately held by the pressing mechanism 80 when the plunger section 130 is inserted into the syringe section 120. Further, the pressing mechanism 80 may perform an operation in the direction of withdrawing the plunger section 130 from the syringe section 120. At that time, the operation can be performed by holding the cap 110 by the pressing mechanism 80.

The cap 110 includes a vent section 112 (vent hole) for communicating the space (internal hollow space) in the internal portion 620 of the cylindrical section 131 of the plunger section 130 with the outside. As shown in FIGS. 15A to 15E, the cap 110 includes a barrel section 111 having a cylindrical shape and a crown section 113 having a larger outer diameter than that of the barrel section 111 at an end on the opposite side to the side where the barrel section 111 is inserted into the plunger section 130. The barrel section 111 and the crown section 113 are integrally formed, and the vent section 112 is internally formed passing through both sections.

Further, the cap 110 includes a breathable sheet 114 disposed to close the vent section 112 (vent hole). The sheet 114 may be any as long as it has breathability, and the material, shape, thickness, etc. are arbitrary. The sheet 114 has breathability such that when the plunger section 130 is moved in a state where the cap 110 is attached, the internal pressure of the biologically relevant material purification cartridge 1 is not greatly changed.

In the example shown in the drawings, the sheet 114 is provided by being pasted with an adhesive (not shown) to a stepped portion 118 on the inner surface of the vent section 112 of the cap 110. The method for placing the sheet 114 or the position where the sheet 114 is placed is not limited, however, by providing the sheet 114 as shown in the drawings, the production of the cap 110 can be facilitated, and also when the cap 110 is used, other substances such as a finger of a user can be made less likely to come in contact with the sheet 114, so that contamination or the like can be reduced. In the example shown in the drawings, the sheet 114 is provided by pasting, but may be provided by another method such as mechanical fixing or integral formation with the cap 110. The sheet 114 is not particularly limited, and a cloth, a non-woven fabric, or a porous film, each composed of any of various materials, or a laminate thereof can be used.

As already described, in the internal portion of the plunger section 130, an adsorption liquid (liquid) and a gas are present. After the cap 110 is attached to the plunger section 130, if the biologically relevant material purification cartridge 1 is left to stand in an erected state, the adsorption liquid never comes in contact with the sheet 114. However, after the cap 110 is attached to the plunger section 130, if the cartridge is turned upside down or is shaken, the adsorption liquid may sometimes come in contact with the sheet 114. In such a case, if the entire surface of the sheet 114 is wet, the breathability of the sheet 114 may sometimes be lost, or when the plunger section 130 is pushed into the syringe section 120 in such a state, a portion of the adsorption liquid may sometimes leak outside the sheet 114.

In light of this, the sheet 114 preferably contains a water-repellent material. Examples of the water-repellent material include a fluorine-based polymer, a silicone-based polymer (silicone resin), and an olefin-based polymer. More specifically, examples of the fluorine-based polymer include polytetrafluoroethylene (PTFE), polyvinylidene fluoride (PVDF), polyvinyl fluoride (PVF), and a copolymer thereof and a blended material thereof. Examples of the olefin-based polymer include polyethylene, polypropylene, and a copolymer thereof and a blended material thereof.

Further, as the sheet 114, a commercially available waterproof moisture-permeable film can be used. Specific examples thereof include Gore-Tex (registered trademark), Hydro Breeze (registered trademark), Drytec (registered trademark), HIREC (registered trademark), and Multipore (registered trademark) (each has water repellency and breathability), and these can be used alone, in combination, or the like.

In the case where the sheet 114 is in the form of a laminate, it is more effective that at least the water-repellent material is disposed on the side of the plunger section 130. Further, in the case where the sheet 114 is formed from polypropylene, the sheet 114 can be integrally formed with the cap 110. Further, the sheet 114 may be formed such that after a sheet is formed from a material having low water repellency, a water-repellent surface is formed by coating or the like. Examples of such coating include coating with a fluorine-containing compound. Also in such a case, the sheet 114 can be regarded as being configured to include a water-repellent material. Further, the surface of the sheet 114 on the side of the plunger section 130 may be subjected to so-called a super-water-repellent treatment (formation of a fractal structure or the like).

By including a water-repellent material in the sheet 114, even if the sheet 114 comes in contact with the adsorption liquid, the wetting of the entire surface thereof is suppressed, and the breathability can be favorably ensured.

As shown in FIGS. 15A to 15D, the cap 110 of this embodiment has a mesh 116. The mesh 116 has a net-like shape, and is disposed on the side of the internal hollow space of the plunger section 130 closer than the sheet 114. Further, the mesh 116 is provided spaced apart from the sheet 114. The mesh 116 has a function to make the adsorption liquid less likely to adhere to the sheet 114, and therefore is preferably provided spaced apart from the sheet 114.

The mesh 116 is provided to close the vent section 112 and ensures the breathability through the openings of the mesh. The opening size of the mesh 116 is such that the liquid droplet of the adsorption liquid hardly passes therethrough. That is, in consideration of the magnitude of the surface tension of the adsorption liquid, the opening size of the mesh 116 is determined such that the opening size makes it disadvantageous for the adsorption liquid to turn into a liquid droplet to form a new surface from the viewpoint of free energy when the adsorption liquid passes through the mesh 116. Specifically, the opening size of the mesh 116 is, for example, 0.01 mm or more and 0.1 mm or less. By setting the opening size to 0.01 mm or more, sufficient breathability can be ensured, and by setting the opening size to 0.1 mm or less, the permeation of the adsorption liquid can be sufficiently suppressed. Incidentally, the “opening size” is the maximum length of the through-hole of the mesh 116.

By providing the mesh 116, the adsorption liquid in a liquid state is less likely to leak outside the plunger section 130. According to this, the contact of the adsorption liquid with the sheet 114 is further suppressed.

In the cap 110 of this embodiment, both of the sheet 114 and the mesh 116 are provided as a preferred embodiment. However, in the case where the sheet 114 contains a water-repellent material, the cap 110 can favorably function even if the mesh 116 is not present. Further, in the case where the sheet 114 does not contain a water-repellent material, by the presence of the mesh 116, the wetting of the entire surface of the sheet 114 with the adsorption liquid can be suppressed.

Incidentally, a case where the cap 110 of this embodiment includes the sheet 114 and the mesh 116 has been described, however, the cap 110 may include a plurality of (for example, two) sheets 114. For example, at the position of the mesh 116 described above, the sheet 114 may be disposed in place of the mesh 116. Also in such a case, the breathability can be ensured, and also the leakage of the adsorption liquid can be suppressed.

### 5-4. Operation of Plunger in Purification Treatment and Effect of Cap

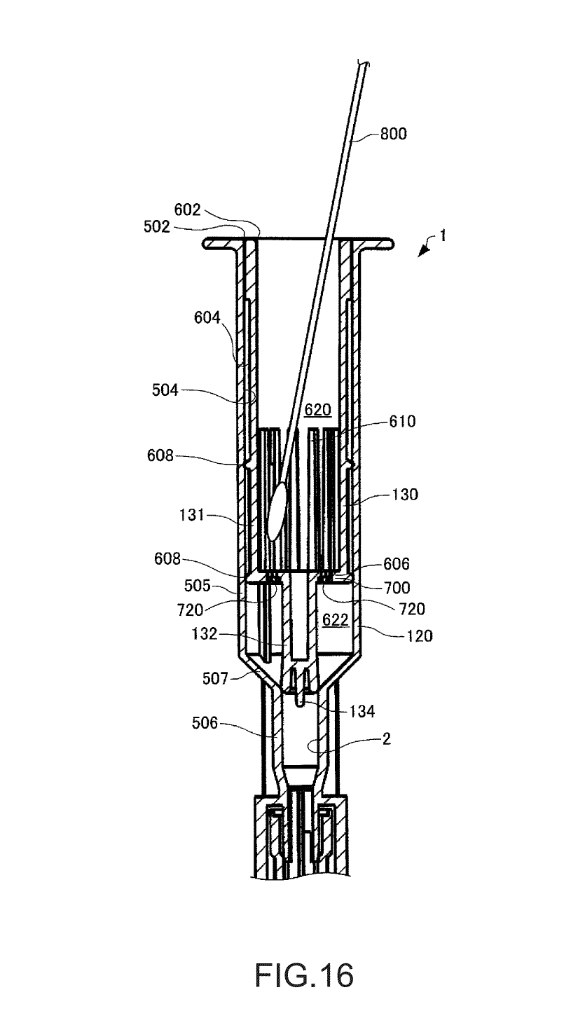

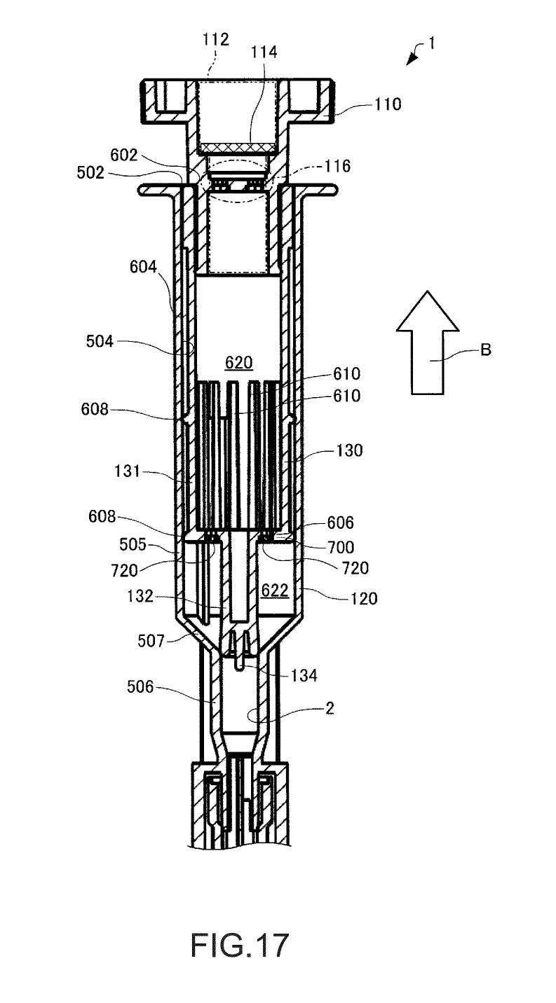

FIGS. 16 and 17 are views for illustrating a method for removing contaminants from a sample using the biologically relevant material purification cartridge 1. Incidentally, in FIGS. 16 and 17, the illustration of the content in the biologically relevant material purification cartridge 1 is omitted for the sake of convenience.

As shown in FIG. 16, a sample containing a nucleic acid and contaminants is placed in the internal portion 620 of the cylindrical section 131 of the plunger section 130. Specifically, in a state where the cap 110 is detached from the plunger section 130, a cotton swab 800 in which the sample is adhered to the tip is inserted into the internal portion 620 from the opening end section 602. For example, by rubbing the tip of the cotton swab 800 against the protrusion 610 provided on the inner peripheral surface of the plunger section 130, the sample can be detached from the tip of the cotton swab 800. In this manner, the sample can be placed in the internal portion 620 of the cylindrical section 131. The nucleic acid contained in the sample is dissolved or dispersed in the adsorption liquid 10 (see FIGS. 7A and 7B, etc.). On the other hand, the contaminants contained in the sample are not dissolved in the adsorption liquid 10.

Subsequently, as shown in FIG. 17, the plunger section 130 is moved to the direction B (withdrawal direction) opposite to the insertion direction A (see FIG. 11) with respect to the syringe section 120. Specifically, after the opening end section 602 of the plunger section 130 is sealed with the cap 110, the plunger section 130 is moved to the direction B with respect to the syringe section 120. In this step, the nucleic acid contained in the sample passes through the filter 700 along with the adsorption liquid 10 and is discharged to an external portion (which is an external portion of the plunger section 130 and is an internal portion of the syringe section 120) 622 of the plunger section 130. The liquid surface of the adsorption liquid 10 descends with respect to the filter 700. On the other hand, the contaminants contained in the sample are larger than the through-hole 720 of the filter 700, and therefore, cannot pass through the filter 700. Accordingly, the nucleic acid and the contaminants are separated. The movement of the plunger section 130 with respect to the syringe section 120 is performed by, for example, the PCR device 50 (see FIG. 9).

In this step, by moving the plunger section 130 in the direction of withdrawal from the syringe section 120, the volume of the space on the lower side of the sheet 114 of the cap 110 (in the biologically relevant material purification cartridge 1) increases (see also FIG. 7B). Therefore, if the sheet 114 does not have breathability, the internal pressure of the biologically relevant material purification cartridge 1 decreases. In such a case, the positions of the other plugs may be moved from the predetermined positions. On the other hand, in the cap 110 of this embodiment, the sheet 114 has breathability, and therefore, the decrease in the internal pressure of the biologically relevant material purification cartridge 1 is suppressed. According to this, the other plugs can be stably maintained at predetermined positions.

Subsequently, as shown in FIGS. 7B and 8A, the nucleic acid is adsorbed onto the magnetic beads 30, and the magnetic beads 30 having the nucleic acid adsorbed thereon are moved while applying the magnetic force of the magnet 3 thereto from the outside of the adsorption container 100, the washing container 200, and the elution container 300. Then, the nucleic acid is eluted from the magnetic beads 30 into the liquid droplet 36 of the eluent in the elution container 300. Thereafter, as shown in FIG. 8B, the cap 110 is pushed to push down the first oil 20 by the tip section 134 of the plunger section 130 (see the direction of the arrow A in FIG. 11), whereby while maintaining the magnetic beads 30 to which the magnetic force of the magnet 3 is applied at a predetermined position, the liquid droplet 36 of the eluent in which the target nucleic acid is eluted is moved into the reaction container 400 and is contacted with the reagent 34 present in the lowermost portion in the reaction container 400.

In this step, by moving the plunger section 130 in the direction of insertion into the syringe section 120, the volume of the space on the lower side of the sheet 114 of the cap 110 (in the biologically relevant material purification cartridge 1) decreases (see FIGS. 8A and 8B). Therefore, if the sheet 114 does not have breathability, the internal pressure of the biologically relevant material purification cartridge 1 increases earlier than when the tip section 134 of the plunger section 130 is fitted to the second portion (small-diameter portion) 506 of the syringe section 120. In such a case, the positions of the other plugs may be moved from the predetermined positions at an unintended time.

On the other hand, in the cap 110 of this embodiment, the sheet 114 has breathability, and therefore, the increase in the internal pressure of the biologically relevant material purification cartridge 1 is suppressed. According to this, the other plugs can be stably maintained at predetermined positions, and by pushing down the first oil 20 by the tip section 134 of the plunger section 130, the liquid droplet 36 can be moved into the reaction container 400 as intended.

The invention is not limited to the above-mentioned embodiments, and further, various modifications can be made. For example, the invention includes substantially the same configurations (for example, configurations having the same functions, methods, and results, or configurations having the same objects and effects) as the configurations described in the embodiments. In addition, the invention includes configurations in which parts which are not essential in the configurations described in the embodiments are substituted. In addition, the invention includes configurations that exhibit the same operations and effects as those of the configurations described in the embodiments, or configurations that can achieve the same objects. In addition, the invention includes configurations in which well-known techniques are added to the configurations described in the embodiments.

The entire disclosure of Japanese Patent Application No. 2015-039936, filed Mar. 2, 2015 is expressly incorporated by reference herein.

What is claimed is:

1. A biologically relevant material purification cartridge, comprising:
a syringe which has a first portion and a second portion with a smaller inner diameter than that of the first portion;
a plunger which has a cylindrical section capable of being fitted to an inner peripheral surface of the first portion and a rod-shaped section supported by the cylindrical section and capable of being fitted to an inner peripheral surface of the second portion, and can be inserted from the side of the first portion of the syringe, and can move in the insertion direction with respect to the syringe; and
a cap which has a vent hole for communicating the internal space of the cylindrical section with the outside and a breathable sheet disposed to close the vent hole, and is connected to the cylindrical section.

2. The biologically relevant material purification cartridge according to claim 1, wherein the sheet contains a water-repellent material.

3. The biologically relevant material purification cartridge according to claim 1, wherein a liquid is disposed inside the cylindrical section.

4. The biologically relevant material purification cartridge according to claim 1, wherein a mesh is disposed on the vent hole of the cap, and the mesh is disposed on the side of the internal space of the plunger closer than the sheet.

5. The biologically relevant material purification cartridge according to claim 1, wherein
the cartridge includes an adsorption container which seals and holds an adsorption liquid for adsorbing a biologically relevant material onto a material binding solid phase carrier and a fluid immiscible with the adsorption liquid, and an elution container which seals and holds an eluent for eluting the biologically relevant material from the material binding solid phase carrier and a fluid immiscible with the eluent, and
the adsorption container includes the syringe, the plunger, and the cap.
